(19) United States
(12) Patent Application Publication
(10) Pub. No.: US 2026/0063297 A1
(43) Pub. Date: Mar. 5, 2026

(54) MONOLITHIC FUEL NOZZLE ASSEMBLY MANUFACTURED USING ADDITIVE MANUFACTURING

(71) Applicant: PRATT & WHITNEY CANADA CORP., Longueuil (CA)

(72) Inventor: Raphael Paquet, Boucherville (CA)

(21) Appl. No.: 18/823,075

(22) Filed: Sep. 3, 2024

(51) Int. Cl. F23R 3/28; F23R 3/60

(52) U.S. Cl. CPC F23R 3/283; F23R 3/60; F23R 2900/00017

(57) ABSTRACT

A monolithic body and fuel injector with the monolithic body include a mount portion, a stem portion, and a heat shield portion. The stem portion and the heat shield portion extend from the first surface of the mount portion. The heat shield portion circumscribes at least a portion of the stem portion. The second surface of the mount portion defines a first interface, and a distal end of the stem portion defines a second interface for joining the monolithic body with components of the fuel injector.

### BACKGROUND

This disclosure relates generally to combustion systems for turbomachinery, and more specifically to components of a fuel injector.

A fuel injector typically contains many unitary components that are connected to each other using either weld joints or braze joints. The fuel injector components are joined using a multi-step process which can offer many complications. Manufacture of each component typically uses conventional machining methods such as casting, milling, and drilling as well as electro-discharge machining techniques. While these methods are considered satisfactory for the intended purpose, further refinement of the fuel injector assembly to reduce manufacturing complexity, time, and cost is highly desirable.

### SUMMARY

A monolithic body according to an example embodiment of this disclosure, among other possible things, includes a mount portion, a stem portion, and a heat shield portion. The mount portion includes a second surface opposite a first surface. The second surface includes a first interface for mating with a component. The stem portion extends from the first surface of the mount portion and is normal to the first surface. The heat shield portion extends from the first surface of the mount portion and circumscribes at least a portion of the stem portion. The distal end of the stem portion defines a second interface for mating with another component.

A fuel injector according to an example embodiment of this disclosure, among other possible things, includes a monolithic body, a manifold, and a nozzle. The monolithic body includes a mount portion, a stem portion, and a heat shield portion. The mount portion includes a second surface opposite a first surface. The second surface includes a first interface for mating with a component. The stem portion extends from the first surface of the mount portion and is normal to the first surface. The heat shield portion extends from the first surface of the mount portion and circumscribes at least a portion of the stem portion. The distal end of the stem portion defines a second interface for mating with another component. The manifold joins to the mount portion at the first interface. The nozzle joins to the stem portion at the second interface.

### BRIEF DESCRIPTION OF THE DRAWINGS

FIG. 1 is an isometric view of an example monolithic body that includes a mount portion, a stem portion, and a heat shield portion of a fuel injector.

FIG. 2 is a cross-sectional view of the monolithic body of FIG. 1 taken along line A-A which depicts additional features of the monolithic body, a nozzle, and a manifold.

### DETAILED DESCRIPTION

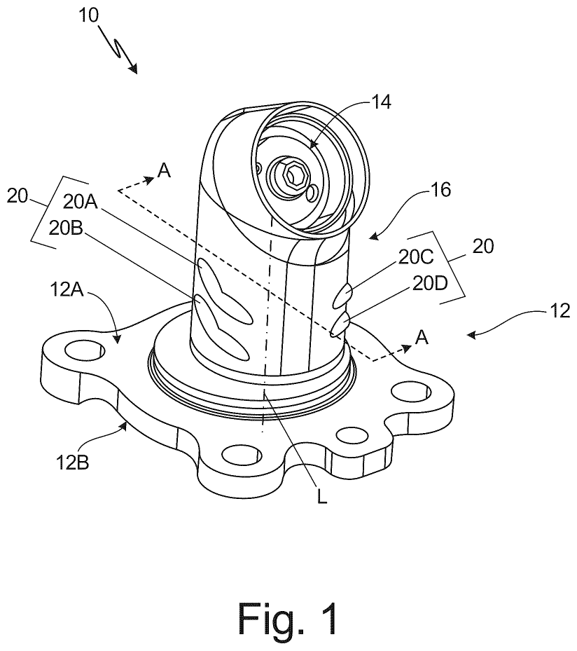

FIG. 1 is an isometric view of monolithic body 10 which combines a mount, a stem, and a heat shield of a fuel injector into a single unitary body. Portions of monolithic body 10 forming the mount, the stem, and the heat shield are referred to as mount portion 12, stem portion 14, and heat shield portion 16, respectively. Monolithic body 10 facilitates reduced manufacturing time and manufacturing cost for gas turbine engine fuel injectors, which can be readily joined with a nozzle and/or a manifold to form a fuel injector. The fuel injector includes at least one fuel path from the manifold through the monolithic body 10 to the nozzle. Further, monolithic body 10 can accommodate multiple nozzle configurations and/or multiple manifold configurations with respective interfaces common between multiple nozzles and monolithic body 10, and between multiple manifolds and monolithic body 10.

Mount portion 12 supports monolithic body 10 and, thereby supports the fuel injector, from a stationary structure of the gas turbine engine, for example, a casing surround a combustor. One or more flanges, lips, and/or pilot diameters allow mount portion 12 to interface with the stationary structure. Mount portion 12 further includes one or more fasteners, keys, and/or pins for affixing monolithic body 10 relative to the stationary structure and the combustor of the gas turbine engine. As depicted, mount portion 12 is a flange that includes first surface 12A and second surface 12B spaced from first surface 12A to an opposite side of mount portion 12. Further, mount portion 12 can include clearance holes extending through mount portion 12 from first surface 12A to second surface 12B for receiving respective fasteners when installed within the gas turbine engine combustor.

Stem portion 14 extends longitudinally from mount portion 12 and includes one or more fuel passages that extend through mount portion 12 and stem portion 14. Stem portion 14 can extend linearly from mount portion 12 such that stem portion 14 is devoid of bends or elbows. In other examples, stem portion 14 can include one or more linear sections connected by respective bends such that a longitudinal axis of stem portion 14 represented by dashed line L changes at each bend relative to an adjacent linear section of stem portion 14. As depicted, stem portion 14 extends outward from mount portion 12 and is normal to first surface 12A of mount portion 12.

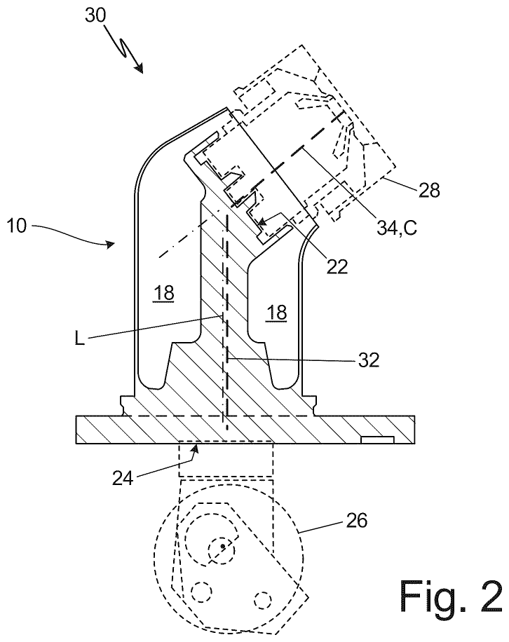

Heat shield portion 16 extends from first surface 12A of mount portion 12 to circumscribe at least a portion of stem portion 14. In some examples, the longitudinal extent of heat shield portion 16 overlaps the longitudinal extent of stem portion 14. Overlapping portions of heat shield portion 16 and stem portion 14 form annular cavity 18 as shown in FIG. 2, which can have a variable cross-sectional area normal to a local longitudinal direction of stem portion 14. In operation, air trapped within cavity 18 between heat shield portion 16 and stem portion 14 insulate stem portion 14 and, thereby protect fuel passages from high combustion temperatures. A distal end of heat shield portion 16 can form an annular gap with a distal end of stem portion 14 in some examples.

Monolithic body 10 can include one or more protrusions 20 extending outward from an exterior surface of heat shield portion 16 in some examples. Each protrusion 20 disrupts air flowing around heat shield portion 16, generating a vortex downstream from heat shield portion 16 within the gas turbine engine combustor. In some examples, monolithic body 10 includes a single protrusion 20 extending outward from a lateral exterior side of heat shield portion 16. In other examples, monolithic body 10 includes multiple protrusions 20, each protrusion 20 extending outward from the lateral exterior side of heat shield portion 16 as shown in FIG. 1. Examples of monolithic body 10 with multiple protrusions 20 can include a first subset of protrusions extending from a first lateral side of heat shield portion 16 and a second subset of protrusions extending from a second lateral side of heat shield portion 16 opposite the first lateral side. For example only, as depicted, monolithic body 10 includes four protrusions 20. Protrusions 20A and 20B form a first subset, and protrusions 20C and 20D form a second subset, each subset extending from opposite lateral sides of heat shield portion 16.

Monolithic body 10 includes one or more interfaces, each interface adapted to join monolithic body 10 to an adjacent component of the fuel injector. FIG. 2 is a cross-sectional view of monolithic body 10 taken along line A-A in FIG. 1 that depicts first interface 22 at a distal end of stem portion 14 and second interface 24 at second surface 12B of mount portion 12. First interface 22 and second interface 24 includes features adapted to interface with an adjacent component. Features of first interface 22 and/or second interface 24 can include one or more of a planar surface, an interior cylindrical surface (i.e., a bore), a cylindrical exterior surface, a chamfer, a radius, a frustoconical surface, a groove, a lip, and combinations thereof among other potential features and combinations. Features of first interface 22 and second interface 24 can be configured to mate with corresponding features of the adjacent component such as the fuel injector, or can be configured to form a gap with corresponding features of the adjacent component.

FIG. 2 depicts monolithic body 10 along with an example manifold 26 and nozzle 28, depicted by dashed lines. Manifold 26 joins to monolithic body 10 at first interface 22, and nozzle 28 joins to monolithic body 10 at second interface 24, each interface having features complimentary to manifold 26 and nozzle 28 respectively. In some examples, first interface 22 can be common to multiple nozzles 28, such that multiple nozzle configurations can be manufactured using the same monolithic body 10. Similarly, second interface 24 can be common to multiple manifolds 26, enabling multiple manifold configurations to be manufactured using a common monolithic body 10 configuration.

Manifold 26 is outboard of mount portion 12 relative to an engine axis and includes supply lines fluidly communicating with a fuel source and/or one or more other adjacent injectors. Manifold 26 can include one or more pipes, conduits, hoses, and/or internal passages to define supply lines, which communicate with one or more fuel passages of stem portion 14.

Nozzle 28 is disposed at a distal end of stem portion 14 and, when installed in gas turbine engine, is at least partially disposed within the combustion chamber and extends along nozzle axis C parallel to a distal portion of stem portion 14. Nozzle 28 forms a discharge end of the injector and can include one or more fuel passages, fuel nozzles, air passages, air nozzles, and/or air swirlers formed by a monolithic nozzle body or formed by an assembly of subcomponents joined together to form features of nozzle 28. For example, a nozzle assembly can include a center body and one or more annular bodies concentrically disposed with respect to the center body to form one or more fuel passages configured discharge fuel along nozzle axis A. Further examples of the nozzle assembly can include an air swirler disposed about an exterior annular body of nozzle 28 to direct a circumferential flow of air to mix with discharged fuel. Each of the one or more fuel passages fluidly connect to at least one of the fuel passages of stem portion 14 to define respective fuel paths between manifold 26 and nozzle 28. Further, the annular bodies of nozzle 28 form at least one gaseous passage for directing oxidant through nozzle 28 to mix with fuel discharged through fuel paths of injector 30.

Monolithic body 10, manifold 26, and nozzle 28 form fuel injector 30. Manifold 26, fuel passage 32 of stem portion 14, and discharge passage 34 of nozzle 28 define a fuel path extending from manifold 26, through monolithic body 10, and discharging at an outlet of nozzle 28.

FIG. 2 further depicts features of heat shield portion 16. At a junction between heat shield portion 16 and mount portion 12, monolithic body 10 can include an increasing cross-sectional area in a direction towards mount portion 12 in which the cross-sectional area is taken normal to a local longitudinal direction of stem portion 14. In the example depicted by FIG. 2, the junction between heat shield portion 16 and mount portion 12 forms a radius along an interior side of heat shield portion 16 and between heat shield portion 16 and stem portion 14. The depicted example further includes a distal end of heat shield portion 16 that is spaced from stem portion 14 and nozzle 28 to form an annular gap. In other examples, a distal end of heat shield portion 16 can define a sliding joint with an exterior surface or an interior surface of nozzle 28 or stem portion 14. In still other examples, a distal end of heat shield portion 16 can form second interface 24 along with stem portion 14 such that heat shield portion 16 and stem portion 14 join with nozzle 28 to completely enclose cavity 18.

Monolithic body 10 can be manufactured, for example, through an additive manufacturing process. In one example, a laser powder bed fusion process is used to manufacture monolithic body 10. Laser powder bed fusion process sequentially deposits layers of material powder, portions of each layer fused to prior layers via a laser. As each layer is formed, a base supporting monolithic body 10 translates to allow subsequent layers to be deposited and fused. The base can be temperature-controlled in order to influence material properties of monolithic body 10 during the manufacturing process. Certain features of monolithic body 10 can be formed after additive manufacturing via subtractive manufacturing processes such as conventional machining processes, electro-discharge machining and/or drilling, among other potential processes. Adjacent components, including nozzle 28 and manifold 26, can be joined to monolithic body 10 via a brazing and/or welding process. Accordingly, monolithic body 10 can be constructed from materials that are more difficult to machine using conventional machining processes while features of monolithic body 10 are produced with an as-finished, or a near as-finished condition that minimizes subsequent machining operations.

### Discussion of Possible Embodiments

The following are non-exclusive descriptions of possible embodiments of the present invention.

### Monolithic Fuel Injector Body

A monolithic body according to an example embodiment of this disclosure, among other possible things, includes a mount portion, a stem portion, and a heat shield portion. The mount portion includes a first surface and a second surface opposite the first surface. The second surface includes a first interface. The stem portion extends from the first surface of the mount portion and is normal to the first surface at the mount portion. The heat shield portion extends from the first surface of the mount portion and circumscribes at least a portion of the stem portion. A distal end of the stem portion includes a second interface.

The monolithic body of the preceding paragraph can optionally include, additionally and/or alternatively, any one or more of the following features, configurations and/or additional components.

A further embodiment of the foregoing monolithic body, wherein a junction between the heat shield portion and the first surface of the mount portion can include a monotonically increasing cross-sectional area in a direction towards the mount portion.

A further embodiment of any of the foregoing monolithic bodies, wherein the junction can form a radius between the heat shield and the first surface of the mount portion, and wherein the radius is between the heat shield and the stem.

A further embodiment of any of the foregoing monolithic bodies, wherein distal ends of the heat shield and stem can be concentric and form an annular gap.

A further embodiment of any of the foregoing monolithic bodies, wherein the monolithic body can further include a protrusion extending outward from an exterior surface of the heat shield portion.

A further embodiment of any of the foregoing monolithic bodies, wherein the protrusion can extend from a lateral side of the heat shield portion.

A further embodiment of any of the foregoing monolithic bodies, wherein the monolithic body can further comprise a plurality of protrusions, each protrusion extending outward from an exterior surface of the heat shield portion.

A further embodiment of any of the foregoing monolithic bodies, wherein the plurality of protrusions can include a first subset of protrusions extending from a first lateral side of the heat shield portion and a second subset of protrusion extending from a second lateral side of the heat shield portion.

A further embodiment of any of the foregoing monolithic bodies, wherein the monolithic body further can include a fuel passage extending through the mount portion and the stem portion.

A Fuel Injector with Monolithic Body

A fuel injector according to an example embodiment of this disclosure, among other possible things, includes a monolithic body, a manifold, and a nozzle. The monolithic body includes a mount portion, a stem portion, and a heat shield portion. The mount portion includes a first surface and a second surface opposite the first surface. The second surface includes a first interface. The stem portion extends from the first surface of the mount portion and is normal to the first surface at the mount portion. The heat shield portion extends from the first surface of the mount portion and circumscribes at least a portion of the stem portion. A distal end of the stem portion defines a second interface. The manifold joins to the mount portion at the first interface. The nozzle joins to the stem portion at the second interface.

The fuel injector of the preceding paragraph can optionally include, additionally and/or alternatively, any one or more of the following features, configurations and/or additional components.

A further embodiment of the foregoing fuel injector, wherein the manifold can be brazed to the monolithic body at the first interface.

A further embodiment of any of the foregoing fuel injectors, wherein the nozzle can be brazed to the monolithic body at the second interface.

A further embodiment of any of the foregoing fuel injectors, wherein the monolithic body further can include a fuel passage extending through the mount portion and the stem portion.

A further embodiment of any of the foregoing fuel injectors, wherein the nozzle can include a discharge passage.

A further embodiment of any of the foregoing fuel injectors, wherein the manifold, the fuel passage, and the discharge passage can be fluidly connected to define a fuel path.

A further embodiment of any of the foregoing fuel injectors, wherein a junction between the heat shield portion and the first surface of the mount portion can include a monotonically increasing cross-sectional area in a direction towards the mount portion.

A further embodiment of any of the foregoing fuel injectors, wherein the junction can form a radius between the heat shield portion and the first surface of the mount portion.

A further embodiment of any of the foregoing fuel injectors, wherein the radius can be between the heat shield portion and the stem portion.

A further embodiment of any of the foregoing fuel injectors, wherein distal ends of the heat shield portion and the stem portion can be concentric and form an annular gap.

A further embodiment of any of the foregoing fuel injectors, wherein the monolithic body can include a protrusion extending outward from an exterior surface of the heat shield portion.

A further embodiment of any of the foregoing fuel injectors, wherein the protrusion can extend from a lateral side of the heat shield portion.

A further embodiment of any of the foregoing fuel injectors, wherein the monolithic body can include a plurality of protrusions, each protrusion extending outward from an exterior surface of the heat shield portion.

A further embodiment of any of the foregoing fuel injectors, wherein the plurality of protrusions can include a first subset of protrusions extending from a first lateral side of the heat shield portion and a second subset of protrusion extending from a second lateral side of the heat shield portion.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A monolithic body for a fuel injector, the monolithic body comprising:
a mount portion having a first surface and a second surface opposite the first surface, wherein the mount portion includes a first interface at the second surface;
a stem portion extending from the first surface of the mount portion, wherein the stem portion is normal to the first surface at the mount portion; and
a heat shield portion extending from the first surface of the mount portion and circumscribing at least a portion of the stem portion;
wherein a distal end of the stem portion includes a second interface, and
wherein the monolithic body is a unitary body in which the mount portion, the stem portion, and the heat shield portion are formed concurrently;
wherein the first interface is common to a plurality of manifolds, each manifold having a different manifold configuration joinable with the first interface; and
wherein the second interface is common to a plurality of nozzles, each nozzle having a different nozzle configuration joinable with the second interface.

2. The monolithic body of claim 1, wherein heat shield portion includes a monotonically increasing cross-sectional area in a direction towards the first surface of the mount portion.

3. The monolithic body of claim 2, wherein the heat shield portion forms a radius along an interior side of the heat shield portion, and wherein the radius is between the heat shield portion and the stem portion.

4. The monolithic body of claim 1, wherein distal ends of the heat shield portion and the stem portion are concentric and form an annular gap.

5. The monolithic body of claim 1, further comprising:
a protrusion extending outward from an exterior surface of the heat shield portion.

6. The monolithic body of claim 5, wherein the protrusion extends from a lateral side of the heat shield portion.

7. The monolithic body of claim 1, further comprising:
a plurality of protrusions, each protrusion extending outward from an exterior surface of the heat shield portion.

8. The monolithic body of claim 7, wherein the plurality of protrusions includes a first subset of protrusions extending from a first lateral side of the heat shield portion and a second subset of protrusions extending from a second lateral side of the heat shield portion.

9. The monolithic body of claim 1, further comprising:
a fuel passage extending through the mount portion and the stem portion.

10. A fuel injector comprising:
a monolithic body comprising:
a mount portion with a first surface and a second surface opposite the first surface, wherein the mount portion includes a first interface at the second surface;
a stem portion extending from the first surface of the mount portion, wherein the stem portion is normal to the first surface at the mount portion; and
a heat shield portion extending from the first surface of the mount portion and circumscribing at least a portion of the stem portion; wherein the stem portion defines a second interface;
wherein the monolithic body is a unitary body in which the mount portion, the stem portion, and the heat shield portion are formed concurrently;
a manifold joined to the mount portion at the first interface, wherein the manifold is one of a plurality of manifolds, each manifold having a different manifold configuration that is joinable with the first interface; and
a nozzle joined to the stem portion at the second interface, wherein the nozzle is one of a plurality of nozzles, each nozzle having a different configuration that is joinable with the second interface.

11. The fuel injector of claim 10, wherein the manifold is brazed to the monolithic body at the first interface, and wherein the nozzle is brazed to the monolithic body at the second interface.

12. The fuel injector of claim 10, wherein the monolithic body further includes a fuel passage extending through the mount portion and the stem portion.

13. The fuel injector of claim 12, wherein the nozzle includes a discharge passage, and wherein the manifold, the fuel passage, and the discharge passage are fluidly connected to define a fuel path.

14. The fuel injector of claim 10, wherein the heat shield portion includes a monotonically increasing cross-sectional area in a direction towards the first surface of the mount portion.

15. The fuel injector of claim 14, wherein the heat shield portion forms a radius along an interior side of the heat shield portion, and wherein the radius is between the heat shield portion and the stem portion.

16. The fuel injector of claim 10, wherein distal ends of the heat shield portion and stem portion are concentric and form an annular gap.

17. The fuel injector of claim 10, wherein the monolithic body comprises a protrusion extending outward from an exterior surface of the heat shield portion.

18. The fuel injector of claim 17, wherein the protrusion extends from a lateral side of the heat shield portion.

19. The fuel injector of claim 10, wherein the monolithic body comprises a plurality of protrusions, each protrusion extending outward from an exterior surface of the heat shield portion.

20. The fuel injector of claim 19, wherein the plurality of protrusions includes a first subset of protrusions extending from a first lateral side of the heat shield portion and a second subset of protrusions-extending from a second lateral side of the heat shield portion.
